(19) United States
(12) Patent Application Publication
(10) Pub. No.: US 2004/0143481 A1
(43) Pub. Date: Jul. 22, 2004

(54) Online business method for surveying customer accessory package preferences

(76) Inventor: Bernard A. Li, Rancho Santa Fe, CA (US)

Correspondence Address: Michael J. Moffatt, Fulwider, Patton, Lee Utecht, LLP, Suite 1550, 200 Oceangate, Long Beach, CA, 90802, US

(21) Appl. No.: 10/348,059

(22) Filed: Jan. 21, 2003

(51) Int. Cl. G06F 17/60

(52) U.S. Cl. 705/10

(57) ABSTRACT

A method for surveying and storing information from users pertaining to vehicle options is disclosed wherein users access a computer network and construct a display of a virtual vehicle from a menu of available vehicle accessories. A graphics interface constructs the display of the user's virtual vehicle with selected options and the user is prompted to submit the unique combination to a first database that is used to influence future product offerings. The method may further include soliciting personal information from the user using an incentive to build a secondary database, where the secondary database is linked to the first database to refine decisions and interpret the first database.

### BACKGROUND OF THE INVENTION

The invention relates generally to online business methods, and more particularly to an online business method for surveying customer preferences with respect to vehicle and motorcycle styling features and options as an aid to forecasting demand for new product combinations.

The use of focus groups is a historic and well-established mode of collecting marketing data for exploratory research of new products. A focus group is typically a collection of six to ten people who are gathered to work with a moderator to discuss a product, service, organization, or other marketing entity. Typically the moderator will have knowledge of the issues to be discussed and a working knowledge of group dynamics and consumer behavior. The participants are normally paid for their time, and the focus group usually takes place in a setting that permits uninterrupted, collegial feedback.

In the example of motorcycle purchase research, the moderator may begin the session by asking about general feelings of a particular product, such as whether the group members own motorcycles or have any intention of buying a motorcycle. Questions then may move to more specific topics, brand name recognition, likes and dislikes, good and bad experiences, and so forth to encourage free discussion and open dialog between the members. The object of the focus group is to delve into the true feelings and desires of the participants in the hope that the dialog will provide insight into the consumer pool at large. All the while, the moderator “focuses” the discussion on the topics that are specifically determined for the particular focus group. The entire process may span several sessions for large ticket items such as automobiles and motorcycles, and the entire process is recorded through note taking or audio/video recording for later studying and analysis to determine consumer beliefs, attitudes, preferences, and behavior. Because the group size is limited to between six and ten people, many focus groups are usually required to provide any meaningful statistical significance to the results.

Focus groups are typically limited to no more than ten individuals to foster individual participation and effective group dynamics. However, as noted above the sample size of a single focus group is far too small to project any consequential statistical significance to the group's conclusions. Moreover, the cost of sponsoring focus groups to achieve statistically significant numbers can be tens or even hundreds of thousands of dollars, which precludes all but the largest companies from engaging focus groups as a marketing tool to project consumer interest in new or potentially new products or services. Additionally, the role and personality of the moderator can very often have a profound effect on the outcome of the focus group and inhibit the true exchange of ideas. Experience has found that moderators can control the direction of the focus group's conclusions and any bias or preconceptions of the moderator can unduly influence the process. Moreover, the realities of group dynamics tend to stifle the flow of ideas and many participants may feel reluctant to express their true beliefs and preferences, especially if they are not aligned with the moderator or the majority. Accordingly, costs and inherent shortcomings of focus groups have created the need for an alternative to research gathering of potential customers without the cost or problems involving group dynamics.

While the use of focus groups may be limited to the most affluent companies, the internet provides a substantially less expensive communications channel for smaller businesses and individuals. The internet has provided a mode of communication between a large group of people and a company that may be useful in gathering information and for educating potential customers regarding available products and services. The internet is a global network that interconnects a remote computer with a plurality of servers that exchange and provide information stored on the servers. Using a software program called a browser, the remote computer contacts the server and sends a request for information in a preferred format such as HTML. The browser then converts the HTML information into graphical and textual data for display on the monitor associated with the remote computer. The information is accessed based on a discrete internet provider address, or IP address. The IP address will typically include a pseudo name referred to as a domain name. By entering the domain name or universal resource locator (URL) into the browser's designated address holder the user is directed to the designated web site and the information stored at the address is communicated to the browser for display. Each individual address is sometimes referred to as a web page, and the entire body of web pages in the network is referred to as the world wide web. Using the Internet, companies can promote their products and service on the world wide web and provide consumer information that can be used by purchasers to make decisions regarding product choices. The proliferation of advertising and information on the world wide web has expanding exponentially in the past ten years and the trends suggest nothing to indicate that the use of the internet to market and promote products will decrease in the future.

The internet has been used previously in both advertising and marketing to some extent. Several patents discussed below demonstrate examples of the internet's expanded role in the marketplace.

U.S. Pat. No. 6,332,129 B1 to Walker et al.

In this patent, a method and system for processing the sales of goods and services utilizing a psychographic questionnaire to gather and assess the buyer's needs and purchasing patterns is described. The questionnaire is used to gather information that may be used to alter a buyer's offer or conditional purchase offer to increase the likelihood of acceptance. In another embodiment, the results of the gathered information are used to determine potential counter-offers if the original offer is rejected. An exemplary process demonstrating the offer and counter-offer steps is illustrated in FIGS. 7A-7C.

U.S. Pat. No. 6,233,564 to Schulze, Jr.

A merchandising system using consumer information from a four survey network system is disclosed in this patent. Referring to FIG. 1, the system 20 includes a telecommunications survey network 28, a written survey network 32, and interactive apparatus survey network 36, and a supplemental survey network 40 coupled to a database network 24 linked to a host computer 44. A number of providers 48 are also coupled to the host and database network.

U.S. Pat. No. 6,196,146 to Goldberg et al.

A web based embroidery system and method is disclosed in this patent. The system is capable of creating a user customized embroidery order over the Internet and automatically fulfilling the order. The user may select a garment and embroidery area on the selected garment and then selected a customized embroidery pattern so that all selections as a simulated end product may be displayed. An embroidery machine may be remotely controlled over the Internet.

U.S. Pat. No. 5,930,768 to Hooban

A method and system enabling a user to remotely customize a product to be manufactured is disclosed in this patent. In the embodiment illustrated in FIGS. 1 and 2 the customer specifies a variety of songs from an inventory of audio media stored in a number of remote databases and selects a playing order. The customer verifies the play list and submits it to the server. The server processes the request and sends an order to a production mechanism for producing the finished audio product by downloading the selected songs to a recording media and shipping the recorded media to the customer.

U.S. Pat. No. 5,893,098 to Peters et al.

A system and method for obtaining and collating survey information from a plurality of computer users in a telecommunications network environment is described and illustrated in this patent. In general terms, referring to the overall block system diagram in FIG. 13, this system includes a survey authoring means 100, 101, 103 and 105 for enabling an author to construct a survey document for each desired survey, a transmission means (FIG. 1) for transmitting the survey questionnaire document to a plurality of respondents, and a processing apparatus with a collating means 109 for receiving and identifying responsive documents. A database 111 is updated with information provided in the responsive documents. As described in the specification, the authoring means is a programmable template for receiving text in the form of a question and further providing the answers to the question. A survey may be built a question at a time. Examples of the authoring template may be found in FIGS. 2-11. The transmission means is a telecommunications network as illustrated in FIG. 1. The collator is a programming module that reads incoming survey response documents and updates the respondents information to the database.

U.S. Pat. No. 5,893,075 to Plainfield et al.

This patent describes an interactive system for surveying customers, primarily in the restaurant services industry. Users are induced to provide the requested information using incentive messages including the possibility of winning random prizes. The results of the survey are used to generate promotional messages tailored to a particular customer. The information is entered into a programmable personal computer made available to the customers in a convenient location as exemplified in FIG. 1. Upon spotting the incentive messages and entering the survey, the customers are queried to enter information relating to name, address, birthdate, and other personal information. The information is stored in record format in a database. The information stored in the database is used to target specific customers with promotional information. Upon completing the survey, the customer is presented with a ticket which informs the customer if he or she has won the prize.

U.S. Pat. No. 5,124,911 to Sack

A method for evaluating consumer choice through concept testing is described in this patent. The method involves a multi-attribute evaluation of prompts comprising concepts and existing products which compete in the same consumer market. Responses related to the extent each attribute ideally should be possessed by a product are elicited from consumers. A deviation and attribute evaluation from the mean are calculated for each prompt or inquiry. Consumers identify those features or positive characteristics of the products at issue that are most desirable in qualitative interviews. Both rational and non-rational characteristics are requested. About 30 to 50 attributes are utilized during the interviewing process. The attributes are grouped into clusters by an independent factor analysis. The clusters represent the underlying factors of the consumer purchase decision. A squeeze analysis is then performed on the attributes by ordering their relative importance. The ordering is achieved by squeezing a multi-dimensional matrix (FIG. 1) and remeasuring the Euclidean distances between points representing the evaluated products and points referencing the ideal product or reference product. An exemplary squeezed analysis result is illustrated in FIG. 2. The resulting squeeze pattern is analyzed and used for targeting customers.

U.S. Pat. No. 5,041,972 to Frost

This patent is directed to a method of measuring and evaluating consumer response for the development of products. In general terms, consumers are presented with a group of related items in qualitative open-ended interviews and requested to identify words which describe each item. The subject items are typically functionally related. During the interviews, customers are asked to identify the rational descriptors which describe the items in terms of function or physical characteristics and the emotional descriptors which describe the emotional reasons a customer would want to purchase the product. The emotional descriptors includes stereotype descriptors which customers use to describe demographic traits of the users of the subject items and personality descriptors which consumers use to personify brands or items. The overall descriptors are reduced to a working subset during the initial interviewing phase and these are made available to the interviewees. The relevance of each descriptor is requested from the interviewee for each of the subject items. Based on the evaluations of the relevance of each descriptor, a discrimination index is generated for each descriptor and the descriptors are ranked. About 30 to 50 descriptors are selected and then the interview process is repeated for each item with the interviewee expressing the relevance and degree of each descriptor with respect to the selected item. Exemplary descriptors are illustrated in FIG. 6. The results are placed on a graph for comparison purposes of determining the most desirable attributes of each item. A squeeze analysis is applied to the attributes to develop a relationship between the distance on the graph between the item and the ideal reference item and the expressed preference for the item. The attributes may be weighted to facilitate predicting changes in the purchase decisions. The data is then interpreted to determine the overall preference for a particular item.

Despite the advances in the online marketing and business method art, there still exists a substantial need in the art for a way to gather information such as user preferences for various prospective product configurations without implicating the shortcomings of using focus groups, so as to utilizes the strengths and capabilities of the internet.

### SUMMARY OF THE INVENTION

The present invention is an online business method for surveying customer preferences in the vehicle and motorcycle industry and for processing the information to make decisions regarding the demand for new products. The invention utilizes online technology to create a graphical survey of accessories and features that may be combined by individual users into a unique combination of elements representing the user's ideal or desired configuration. The selected combination of vehicle options are displayed in graphic form to generate a virtual product embodying the preferred options and accessories chosen by the user. Using the Internet to poll thousands of users as to their individual preferences using the graphical interface of an internet website allows a company to collect uninfluenced and honest responses in numbers that have statistical significance for a fraction of the cost of sponsoring focus groups having the same number of participants. The users can see the motorcycle's or vehicle's appearance as accessories are added using a menu-driven configurator to graphically build the motorcycle or vehicle on the computer screen with the desired accessories, even though the motorcycle or vehicle may not even be offered yet with that particular set of options. The collection of responses are saved as part of a general database of information concerning the most popular accessories and the most popular combinations of accessories, which may be used to aid in making decisions regarding motorcycles or vehicles to be offered by the company in the future.

In addition to the general database, the invention provides for a secondary polling of information regarding the personal information of the particular respondent. To entice the respondent to provide personal information the interface may offer the respondent a chance of winning a sweepstake or contest, or may offer some other benefit to encourage the respondent to include personal information. The responses from those respondents who provide personal information become part of a subset of the general database that links the personal preferences to various disclosed characteristics, such as income level, prospects of purchasing a new motorcycle in the near future, location, and so forth. The responses of these individuals are linked with their personal information to provide a secondary database of personal responses with personal information to improve and refine the marketing decisions more generally suggested by the general database.

### BRIEF DESCRIPTION OF THE DRAWINGS

FIG. 1 is a flow chart illustrating the steps of a preferred embodiment of the present invention;

FIG. 2 is an example of a home page of the method sequence referred to in FIG. 1;

FIG. 3 is an example of a configurator web page for graphically building a vehicle according to a user's preferences;

FIG. 4 is an example of the configurator web page of FIG. 3 illustrating a pull-down menu for vehicle accessory options;

FIGS. 5-8 are examples of the configurator web pages of FIG. 3 illustrating a pull-down menu options for individual vehicle accessories; and

FIG. 9 is an example of a questionnaire used in conjunction with the method of the present invention to solicit personal information about the user.

### DETAILED DESCRIPTION OF THE INVENTION

The present invention uses an internet connection to solicit responses to a query regarding a preferred set of available options on a vehicle such as a motorcycle. The system is devised to recruit respondents by providing an interactive graphical interface that allows a user to design an optimum vehicle based upon the user's individual preferences of vehicle styling elements and/or options. The graphics interface provides real-time, instantaneous visual feedback in the form of a display of a vehicle as configured by the user that allows the user to view what a hypothetical set of vehicle options would look like. This graphical feedback enables the user to choose from among many hundreds of combinations the ideal unique combination based on the user's particular likes and dislikes. Since the combinations of possible options may be in the hundreds or thousands, the present invention allows the visualization of combinations that may not even be offered presently. The anonymity of the internet allows the user to be frank and honest about his preferences without undue influence from other participants, and the bias and control of a moderator is absent from the process described above. Thus, the shortcomings of using focus groups has been avoided while the number of participants is increased and the cost of acquiring individual data is decreased.

The invention is preferably expanded to create a subset of the general database of responses by enticing users to provide personal data about themselves that may be used in further analyzing the responses. By linking information about a user such as income level or purchasing readiness to a set of options and then cross-referencing the personal information with the selection vehicle accessories, a secondary database can be established for refining and focusing the results obtained from the general database. The enticement to provide the user's personal information can be in the form of a contest entry form or a free product catalog, for example, where an information datasheet can be presented to the user for completing prior to concluding the confirmation of contest entry or catalog mailing. In this manner, the general database can be used for obtaining general trends and preferences and the secondary database can be used to refine and focus the results according to specific acquired data. The system can also be used to determine future products that are determined by achieving a minimum response in the survey. Here, the threshold may be a percentage of total responses or a minimum number of responses indicating a preference for a specific combination of accessories.

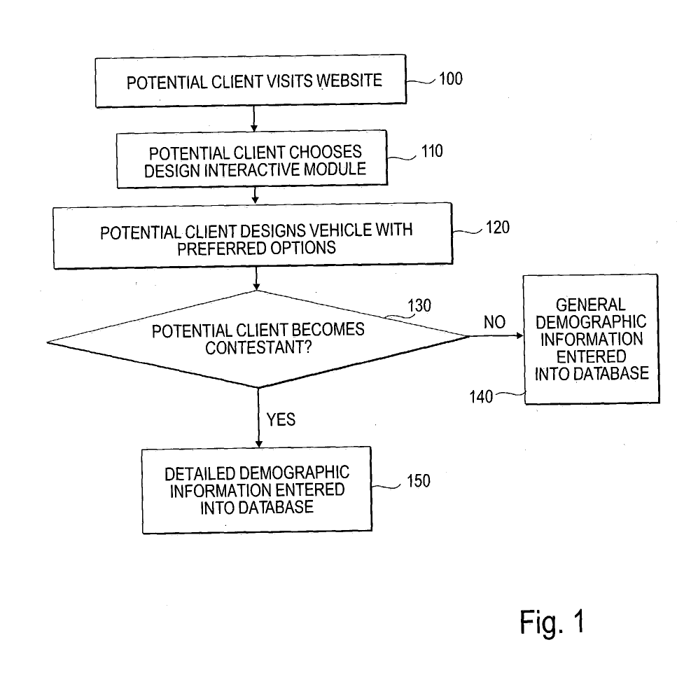

FIG. 1 illustrates a general flow chart of the method of the present invention. In the first step 100, potential clients and customers enter the home page's URL on a remote computer with an internet connection and an browser, and the user is transferred to the home page of the vehicle manufacturer or seller. From the home page, the user is directed to a configurator web page in step 110 which provides a graphical interface for building the user's ideal vehicle on the user's computer screen. By selecting from among various menu options of available accessories, the user constructs a vehicle according to the user's individual tastes and preferences in step 120. After completing the vehicle construction graphically, the user is queried in step 130 whether the user desires to participate in a contest or other incentive program which requires the providing of personal information via a questionnaire. If the user declines, the configurator information of the user's choices are stored in a general database of respondents for whom no specific personal information is known in step 140. If the user accepts the invitation to enter the contest, the user is provided a questionnaire for obtaining personal information and the personal information obtained from the questionnaire is linked with the user's accessory preferences in a detailed database in step 150.

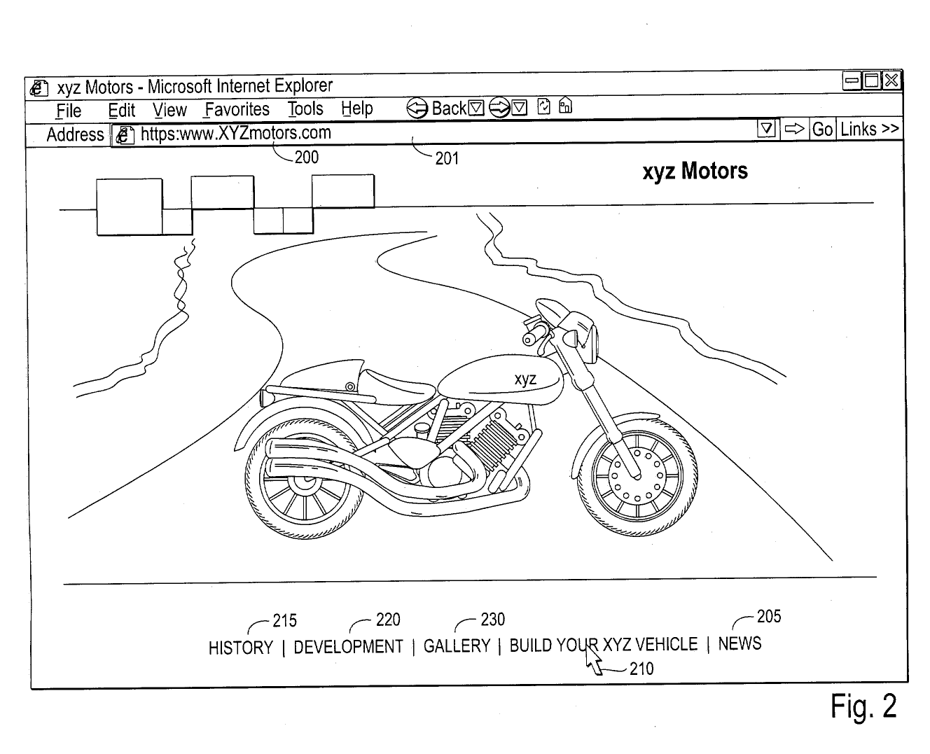

One example of a graphical interface of the present invention is shown generally in FIGS. 2-9, which illustrate web pages for display at a designated web site. To participate in the survey, the user initially enters a predetermined URL 200 into the user's web browser at 201 to direct the user to a splash screen or other introductory welcoming web page. The splash screen may include legal disclaimers and terms and agreements of the web page, but should also include images that pique the interest of the user and invite the user to further explore the web page. Using a mouse or other pointing device, the user clicks on a portal image that redirects the user to a home web page as shown in FIG. 2 having several options. The home page may include links to information such the company's history 215, the development of the company 220, a gallery of company products 230, company news releases 205, as well as contact information for contacting the company directly and frequently asked questions that allow the user to browse questions previously posed by other users. Using the computer's pointing device to locate the links, the user can be transferred to each different web page by clicking on the link associated with the various information options. The home web page of FIG. 2 includes a link 210 to redirect the user to the configurator page, i.e., the page that allows the user to build a virtual motorcycle with options and accessories selected by the user, even if such combinations of accessories are not currently available as a package.

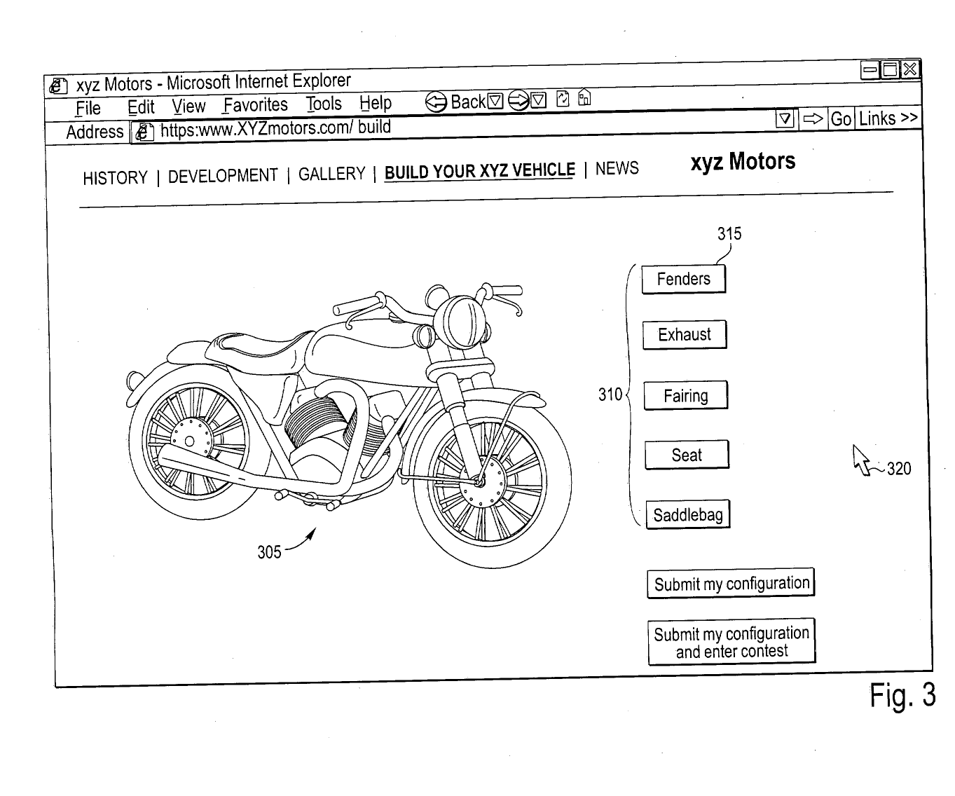

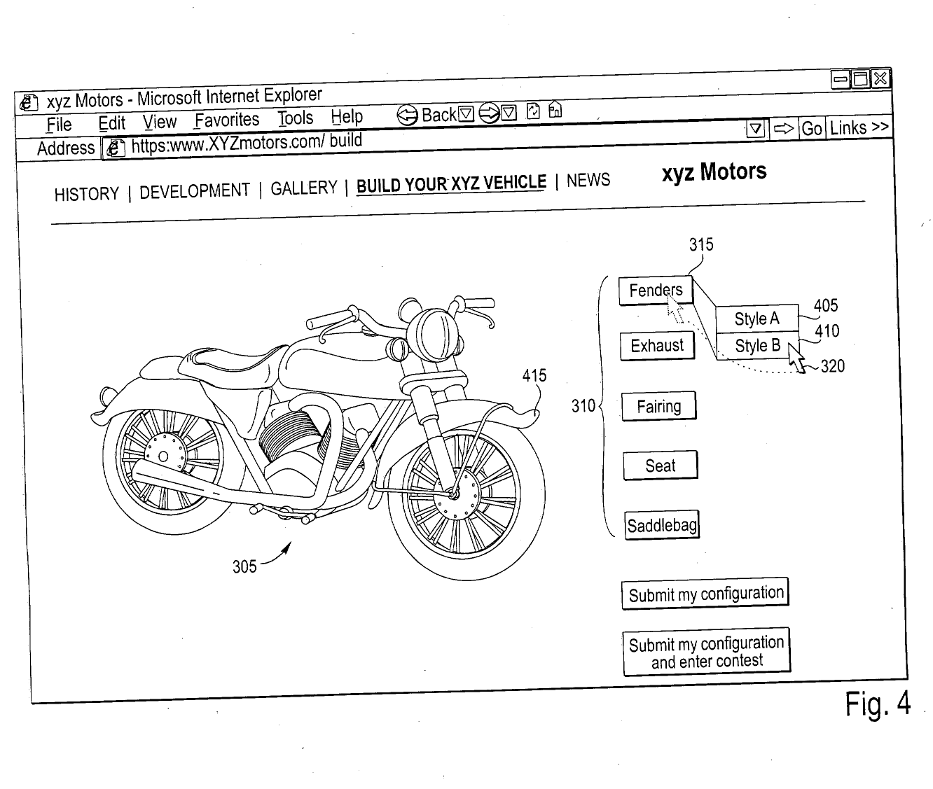

The configurator web page is generally shown in FIGS. 3-8 and preferably includes an image of a stock vehicle or motorcycle 305 that corresponds to the baseline, and a menu 310 of available accessories that may be added to the baseline motorcycle 305 according to the preferences of the user. For example, the menu 310 may have a fender option 315 which, when selected by the user using the pointing device 320, expands as shown in FIG. 4 to reveal a plurality of fender options 405,410. The user can select the various fender options such as sport and standard, and the configurator applies the chosen option 415 to the baseline motorcycle 305 so that the user may observe the options individually on the baseline version and select the fender option most desirable to the particular user. In a preferred embodiment, the graphical interface automatically configures the baseline motorcycle with the selected option as the pointing device 320 is moved over the menu option 405,410, so that the user can rapidly change back and forth between accessory options my moving the pointing device back and forth between two accessory options.

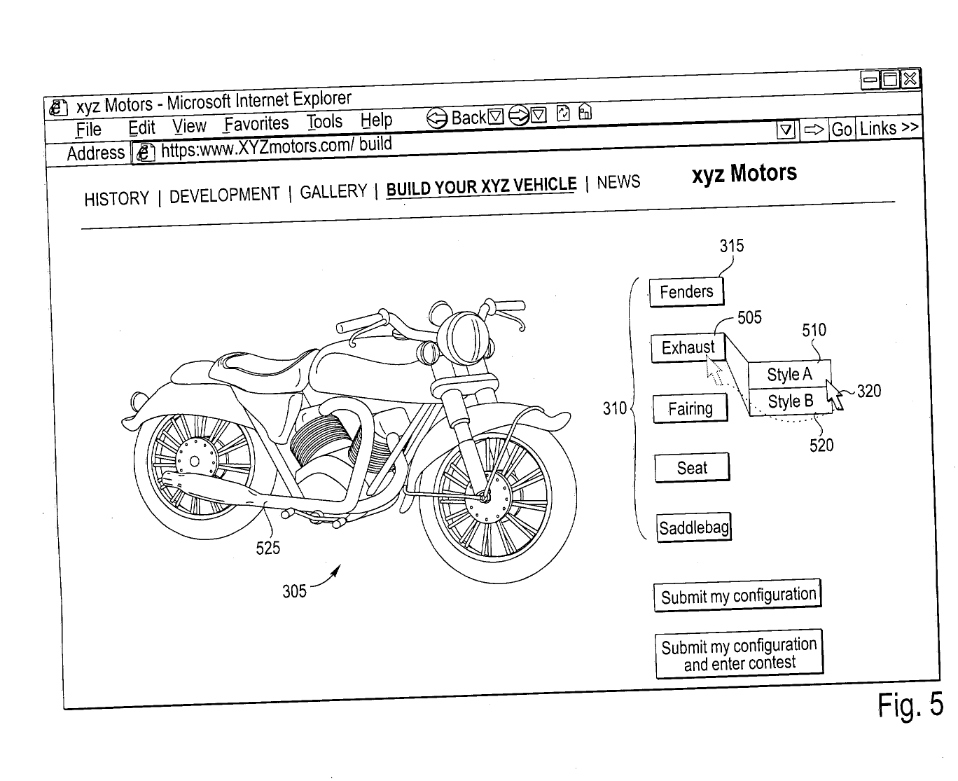

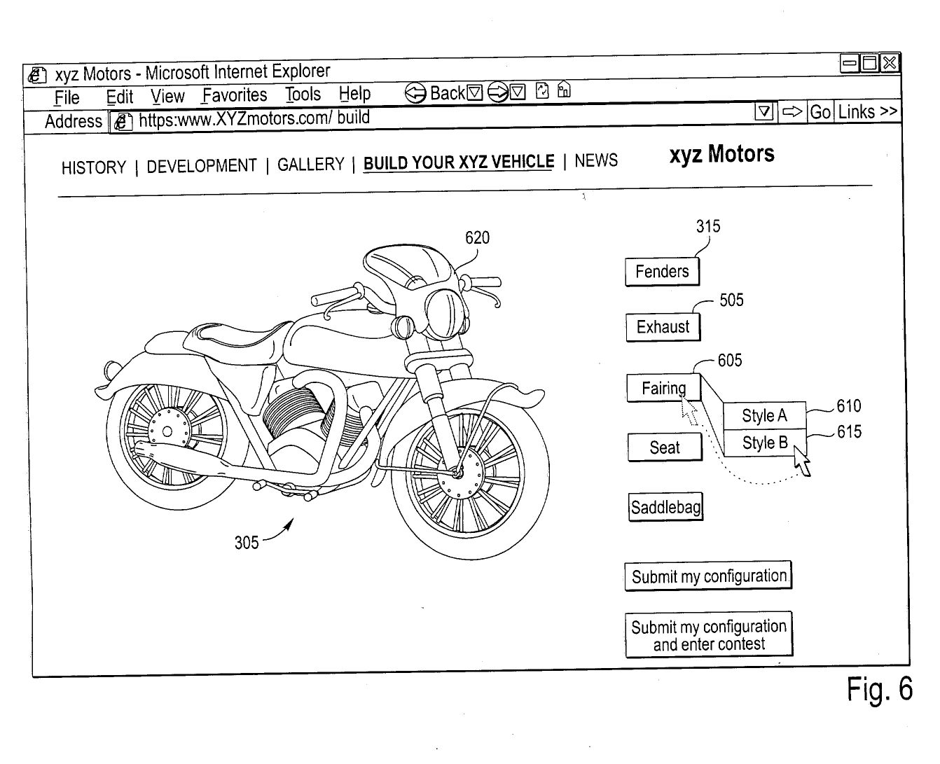

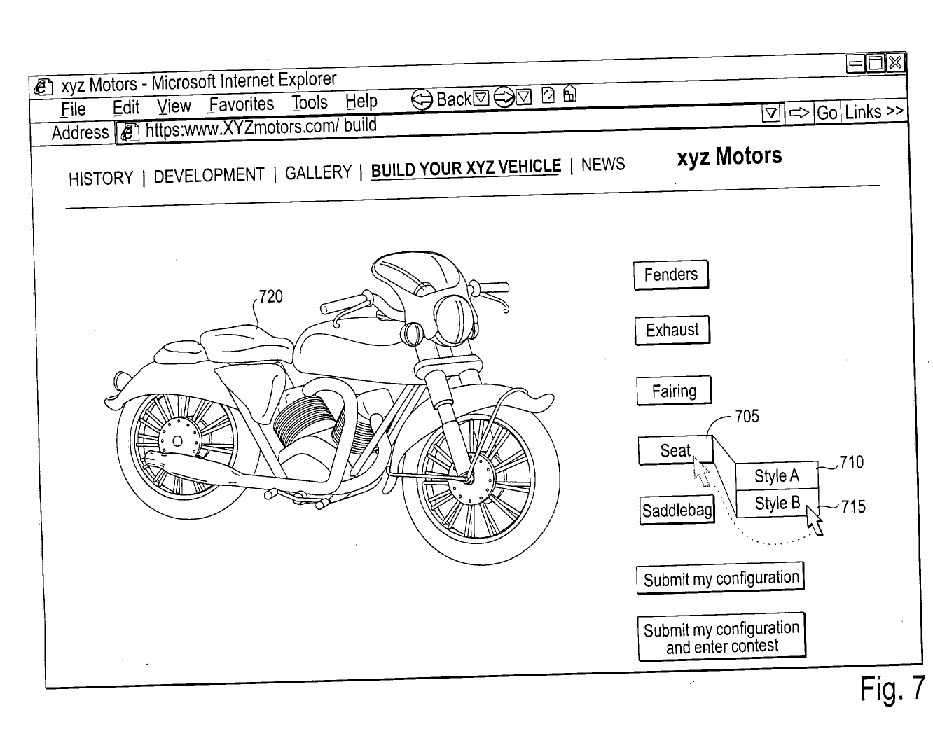

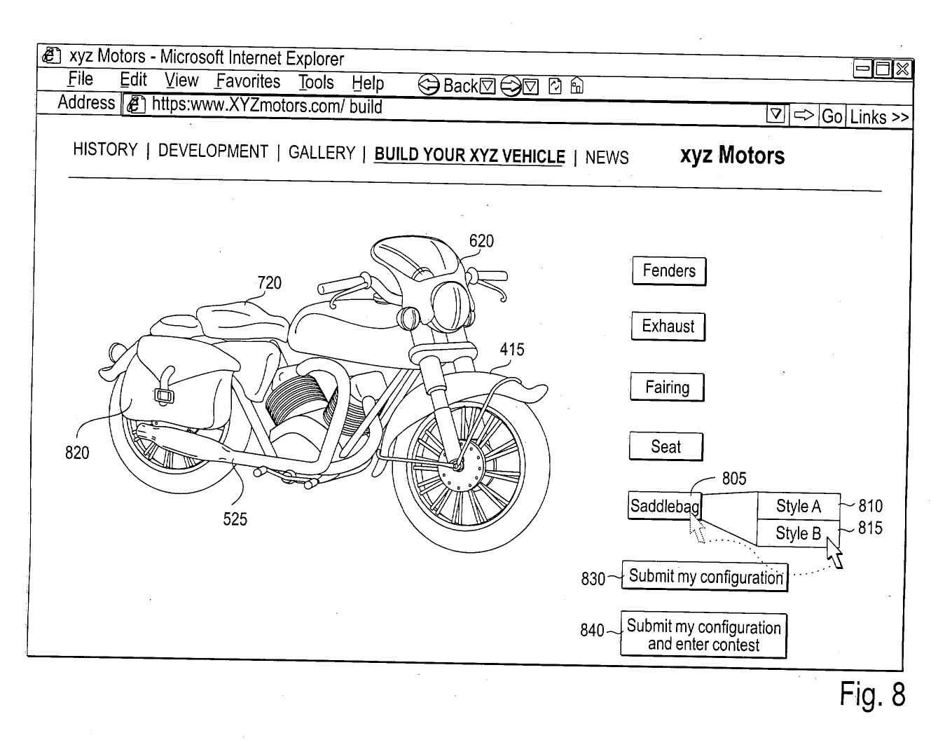

After the fender option has been selected, the user goes to the next option on the menu such as an exhaust pipe option 505. For example, single megaphone, double megaphone, and single tour exhaust pipe options are available and, by selecting the desired options 510, 520, the baseline version 305 with the selected fender option 415 is again updated to include the selected exhaust pipe option 525 as shown in FIG. 5. After the exhaust pipe option 505, the fairing option 605 may be chosen from a list 610,615 of options that might include full, half, and quarter length fairings. The selection option 620 is once again applied to the user's personal configuration of the baseline model 305 in FIG. 6 as the unique combination of selected options is combined graphically into a virtual motorcycle that can be observed by the user. In FIG. 7, a seat menu 705 with options 710,715 such as single, dual, and touring, and in FIG. 8, a saddlebag menu 805 with options 810, 815 are available. Once completed, the baseline vehicle has been accessorized with fender option 410, exhaust option 520, fairing option 615, seat option 715, and saddlebag option 815. This is reflected in FIG. 8 by motorcycle components such as fender 415, exhaust pipes 525, fairing 620, seat 720, and saddlebag 820. It should be understood that the examples provided are illustrative only, and the invention contemplates a variety of options for both vehicles and motorcycles without limitation to those identified here. One of ordinary skill in the art would appreciate that the foregoing description is not limiting as to the invention, but rather demonstrates the concepts for adding components to a baseline model.

As referenced above, in a preferred embodiment of the present invention the graphical representation of the virtual motorcycle with the selected options changes automatically when the pointing device 320, such as a mouse cursor, is moved over a selected option. That is, by moving the mouse pointer back and forth between the single and dual seat options the configurator automatically switches the appearance of the constructed model between the dual seat and the single seat appearances. In this manner, the user can quickly visualize the differences between the two options without reloading the image to enable the user to determine the preferred options more quickly. Options can preferably be changed so that the user can go back and change a previously selected option in view of subsequently selected options. For example, a user may decide after initially choosing a full fairing that the preferred saddlebag option does not look as good, and the configurator allows the user to go back in the menu and reconfigure the virtual model.

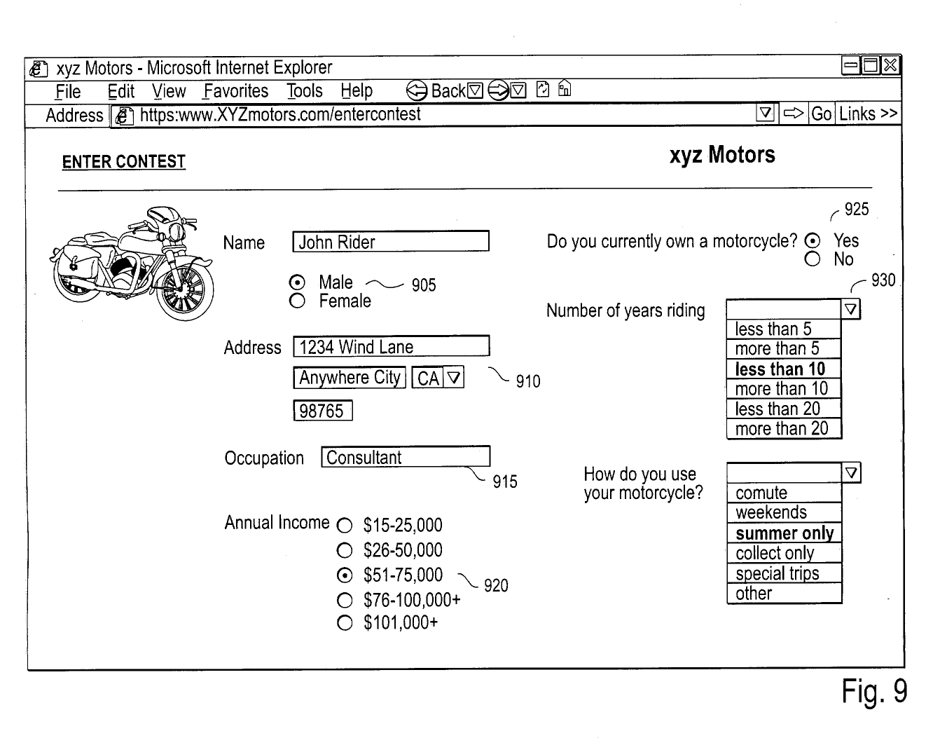

Once all of the options are set to the user's preferences, the user submits the configuration by clicking on one of two options. The first option 830 sends the information regarding the preferred options of the particular user to a general database serviced by the web site operator for storage and further analysis. Alternatively, the web page includes an option 840 for submitting the preferred options and entering a contest to win a prize. If the user selects the contest option 840, the user is redirected to a personal datasheet as shown in FIG. 9 that is filled in by the user to collect information such as gender 905, address 910, occupation 915, income 920, motorcycle experience 930, motorcycle buying probability, present motorcycle ownership 925, and motorcycle preferences regarding styles, manufacturers, and so forth. A link to the contest rules may also be in order. Once the user enters the information in the appropriate boxes, the information is both entered as part of the general database as well as well as a separate database of preferences with specific user information. The personal information can be used to guide the company regarding products offered in the future and gauge the demand for certain products in certain areas or customers of certain income ranges.

An example of the process is illustrative. One thousand users visit the configurator of the web page and decide to build their ideal motorcycle by selecting from among the various available options. Sixty percent of the respondents select a sport fender while forty percent of the respondents choose a standard fender. The dual megaphone exhaust pipe option is the most popular, selected by fifty-five percent of the respondents while single tour is selected by thirty percent and fifteen percent select single megaphone. The no fairing option is selected by forty percent of the respondents, followed by thirty five percent selecting a half fairing and twenty five percent selecting a quarter fairing. The seating options were divided equally among single with cowl, touring and dual. Seventy-five percent of the respondents selected a saddlebag as part of their ideal motorcycle. The information provides unbiased preferences of motorcycle users without the need for focus group interaction. Statistically significant response feedback can be used advantageously to predict trends and revise prospective product offerings in response to the feedback.

The invention may also be used to set up predetermined criteria for establishing a new product comprising a unique combination of accessories based upon a predetermined minimum number of user-selected combinations. For example, if a threshold of ten thousand is established for offering a particular combination of options on a prepackaged model, when a particular unique combination of options is selected by the threshold number of respondents then that combination is automatically placed on a list of motorcycles to be made available for purchase in the future. The criteria can be based upon data from the general database or the secondary specific database with personal information. For example, the criteria could be based only on the respondents who meet a certain income qualification or those respondents who indicate they have a moderate to high chance of purchasing a motorcycle within a given time frame. In this manner, the decision-makers can be confident that the motorcycles it offers meets with the demands of those respondents needs or preferences who are likely to purchase the product.

The results of the hypothetical survey can be further refined to determine the most popular selected options, the least popular selected options, trends with respect to option pairs such as seat and saddlebag combinations or fender and fairing combination preferences. Using statistical analysis, the system can be used to predict purchasing trends before the actual motorcycles are actually built, and tailor the manufacturing of the future built motorcycles to match the preferences of the general database.

Continuing the hypothetical survey, of the one thousand respondents four hundred respondents opted to enter the sweepstakes and provide the requested personal information. This secondary database demonstrates that those most likely to purchase a motorcycle in the near future showed a preference for higher end option combinations as compared with those respondents who indicated that purchasing a motorcycle was not anticipated to be in the near future. This information may influence manufacturing decisions initially based upon the general database. Clearly it is apparent that the personal information database, while statistically smaller than the general database, can be used effectively to monitor the preferences of specific demographics and refine the marketing decisions suggested by the general database.

It should be understood that the foregoing description is illustrative and does not limit or define the invention except as set forth in the claims below. The use of the term motorcycle where used should be understood to be exemplary of a broader class of vehicle that could include automobiles, trucks, boats, bicycles, jet skis, and the like. The use of the term vehicle should be construed as being any of the types of vehicles described above and other types recognizes as falling within the description of vehicle. Moreover, the types of accessories and options will necessarily vary depending upon the type of vehicle being surveyed and the options discussed with respect to the description above play no part of the actual invention aside from their illustrative role in discussing the invention.

What is claimed is:

1. A method for surveying consumer interest in vehicle accessories via online polling comprising the steps of:
providing an interface accessible to remote computers via a computer network;
displaying on the remote computer a menu of a plurality of vehicle options;
prompting a user to select a preferred set of vehicle options from among the menu of available options;
graphically displaying a composite vehicle including the selected vehicle options as configured by the user;
prompting a user to submit a final set of selected vehicle options; and
storing the selected vehicle options in a general database.

2. The method of claim 1 further comprising the step of prompting the user to provide personal information, and storing the personal information in a second database that links the selected vehicle options to the user's personal information.

3. The method of claim 2 further including the step of compiling statistical data of the selected vehicle options cross-referenced with the personal information.

4. The method of claim 2 further including the step of inviting the user to enter a contest as an incentive for providing personal information.

5. The method of claim 1 where the vehicle is a motorcycle.

6. A method for building a database of user responses to vehicle accessory preferences comprising:
providing a web page with a plurality of menu options comprising motorcycle accessories selectable by a user;
providing a graphical program that displays an image of a baseline motorcycle combined with accessories selected by the user; and
providing an option on the web page allowing the user to submit a preferred motorcycle accessories combination to a general database.

7. The method of claim 6 further comprising providing on a web page a questionnaire for receiving from the user personal information about the user, and storing the personal information in a second database.

8. A method for building a database of user responses to vehicle accessory preferences comprising:
providing a web page based interactive interface that allows a user to construct a visual display of a vehicle with accessories selected from a menu of vehicle accessories;
collecting responses from users that participate in the interactive interface and provide a set of vehicle options directed to the user's preferences;
storing the responses in a database for statistical analysis;
prompting the user to provide personal data via an online questionnaire;
storing the personal data in a database; and
linking the personal data to the responses of selected vehicle options.

9. The method of claim 8 where the vehicle is a motorcycle.

10. The method of claim 9 where the vehicle options comprise motorcycle fairing options.

11. The method of claim 9 where the vehicle options comprise motorcycle exhaust pipe options.

12. The method of claim 9 where the vehicle options comprise motorcycle saddlebag options.

13. The method of claim 9 where the vehicle options comprise motorcycle seat options.

14. The method of claim 8 wherein the interface automatically constructs the visual display of the vehicle with accessories when the user moves a pointing device over an option in the menu.
